(19) United States
(12) Patent Application Publication
(10) Pub. No.: US 2026/0331485 A1
(43) Pub. Date: Oct. 22, 2026

(54) ELECTRODE PRECURSOR COMPOSITION

(71) Applicant: Dyson Technology Limited, Malmesbury Wiltshire (GB)

(72) Inventors: Daniel Stephen MACPHERSON, Trowbridge (GB); Liyu JIN, Swindon (GB)

(21) Appl. No.: 19/108,768

(22) PCT Filed: Sep. 11, 2023
(86) PCT No.: PCT/IB2023/058999

§ 371 Date: Mar. 5, 2025

(30) Foreign Application Priority Data
Sep. 15, 2022 (GB) 2213547.9

(51) Int. Cl. H01M 4/525; H01M 4/1391; H01M 4/62; H01M 10/0525; H01M 10/054

(52) U.S. Cl. CPC H01M 4/525; H01M 4/1391; H01M 4/622; H01M 4/625; H01M 10/0525; H01M 10/054

(57) ABSTRACT

Disclosed is a method of preparing an electrode for an alkali metal ion secondary cell, the method may include: mixing polyacrylonitrile, or a copolymer of acrylonitrile and at least one other monomer, or a blend of either of the foregoing with one or more other polymers, with a first organic solvent and an electrochemically active material, to form an electrode precursor composition; forming an electrode precursor from the electrode precursor composition; and forming an electrode by exposing the electrode precursor to an alkali metal salt.

### FIELD OF THE INVENTION

The present invention relates to an electrode precursor composition for an alkali metal ion secondary cell. The invention also relates to electrodes, cells and energy storage devices made from such precursor compositions, along with methods of preparing electrodes for alkali metal ion secondary cells.

### BACKGROUND OF THE INVENTION

Lithium-ion secondary batteries are the leading battery technology currently used in applications from small personal devices to electric vehicles. Lithium-ion batteries are favoured for their high energy density and long cycle life, among other benefits. They contain a plurality of lithium-ion secondary cells.

Traditional lithium ion battery components such as electrodes are made from a solvent cast process that uses sacrificial solvent. This is an energetically expensive step, and a process that avoids using sacrificial solvent is therefore desirable.

One approach to avoiding the use of sacrificial solvent is preparing gel electrodes. These electrodes can be formed from a composition prepared by mixing the necessary components such as electrochemically active material, polymer, and a solvent or liquid electrolyte, and subsequently subjecting the composition to a thermal treatment.

The use of a gel in the preparation of an electrode using thermal processing, for example, must balance two opposing requirements. On the one hand, the gel must be sufficiently soft to be processed to form the electrode during thermal processing. On the other hand, the gel must be sufficiently mechanically robust to be of practical use.

There is a need for gel electrode precursor compositions which satisfy the above criteria.

### SUMMARY OF THE INVENTION

In general, the present inventors propose to address the above problems by making use of the sensitivity of a particular kind of polymer to their chemical environment, and specifically their sensitivity to the presence of alkali metal salt.

The inventors have found that polyacrylonitrile forms soft and pliable, viscous materials in the absence of alkali metal salt, and when alkali metal salt is added subsequently, these materials can be caused to harden. The present invention is based on this finding.

Electrode compositions containing polyacrylonitrile are known, for example from US 2017/162862 A1. However, these compositions do not appear to take advantage of the alkali metal salt sensitivity of the polyacrylonitrile as described herein.

Accordingly, a general proposal of the present invention is to prepare a processable electrode precursor composition containing a polymer containing acrylonitrile monomer having insufficient alkali metal salt to cause hardening, such as in the absence of alkali metal salt. Subsequently, once the electrode precursor composition is subjected to thermal processing and formed into an electrode precursor, the electrode precursor can be hardened by exposing it to an alkali metal salt. Using this general procedure, the inventors find that the electrode precursor composition is highly processable while also forming an electrode with sufficient mechanical robustness and energy density for practical use.

A first aspect of the invention concerns a method of preparing an electrode for an alkali metal ion secondary cell, the method comprising:
a mixing step, comprising mixing polyacrylonitrile, or a copolymer of acrylonitrile and at least one other monomer, or a blend of either of the foregoing with one or more other polymers, with a first organic solvent and an electrochemically active material, to form an electrode precursor composition;
an electrode precursor formation step, in which the electrode precursor composition is formed into an electrode precursor; and
an electrode formation step, comprising exposing the electrode precursor to an alkali metal salt.

In the electrode formation step, the alkali metal salt may be provided in any suitable form. In some embodiments, the method may comprise exposing the electrode precursor to a solution comprising the alkali metal salt. In some embodiments, the method may comprise exposing the electrode precursor to a gel comprising the alkali metal salt.

As will be understood from the foregoing, in general the electrode precursor composition prepared by the mixing step contains a low amount of alkali metal salt, so that the soft and pliable nature of the composition is retained, and it is easy to process into an electrode.

In some embodiments, the electrode precursor composition prepared by the mixing step is free (i.e. contains 0 wt. %) or substantially free (i.e. contains 1 wt. % or less, such as less than 0.5 wt. % or less than 0.2 wt. % or less than 0.1 wt. %) of alkali metal salt to within experimental accuracy.

In some embodiments, the electrode precursor composition contains insufficient alkali metal salt to cause the composition to have the final, desired electrode hardness. In some embodiments, the electrode precursor composition contains between 0 and 25% of the final salt concentration required to achieve the desired electrode hardness.

In this way, the electrode precursor composition can be processed into a thin-film electrode precursor which, in some embodiments, may have a gel-like quality. Subsequently, the electrode precursor is contacted with or exposed to alkali metal salt, causing the electrode precursor to harden into a state of sufficient mechanical robustness for practical use. In some embodiments, the electrode formed after exposure to alkali metal salt has a gel-like quality i.e. is a gel electrode.

In general, and without wishing to be bound by theory, the inventors believe that the method of the present invention can avoid some of the limitations and trade-offs that are usual in the art for electrode preparation, especially with gel electrode preparation. For example, the inventors consider that the present method might permit a higher active capacity, or a more mechanically robust electrode, than is achieved using prior art methods.

According to a second aspect, the present invention concerns an electrode precursor composition suitable for preparing a gel electrode, the composition comprising polyacrylonitrile, or a copolymer of acrylonitrile and at least one other monomer, or a blend of either of the foregoing with one or more other polymers, an organic solvent, and electrochemically active material, which composition is free or substantially free of alkali metal salt.

By “free or substantially free of alkali metal salt”, we preferably mean that the composition is free (i.e. contains 0 wt. %) or substantially free (i.e. contains less than 1 wt. % such as less than 0.5 wt. % or less than 0.2 or 0.1 wt. %) of alkali metal salt to within experimental accuracy.

The electrode precursor composition of the second aspect may be suitably prepared by a mixing step described in the method of the first aspect.

The electrode precursor composition of the second aspect may be suitably processed into an electrode precursor, and/or into an electrode, by the electrode precursor formation and electrode formation steps, respectively, described in the method of the first aspect.

Further aspects concern an electrode precursor prepared from an electrode precursor composition according to the present invention, an electrode for an alkali metal ion secondary cell prepared from an electrode precursor composition or method or electrode precursor according to the present invention, an electrochemical secondary cell, such as an alkali metal ion secondary cell, comprising an electrode precursor or electrode according to the present invention, and an electrochemical energy storage device comprising an electrochemical cell according to the present invention.

### DETAILED DESCRIPTION AND PREFERRED EMBODIMENTS

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

In the following, “electrode precursor composition” refers to both the electrode precursor composition of the second aspect, and the electrode precursor composition which is the result of the mixing step in the method of the first aspect.

Similarly, electrode precursor refers to the electrode precursor of the further aspect, and to the electrode precursor which is formed in the method of the first aspect. Similarly, electrode refers to the electrode of the further aspect, and to the electrode which is formed in the method of the first aspect.

The present invention generally describes the use of particular polymers for forming electrode precursor compositions. The particular polymers are polyacrylonitrile, or a copolymer of acrylonitrile and at least one other monomer, or a blend of either of the foregoing with one or more other polymers. Therefore, it can be seen that the particular polymers can be generally described as those containing acrylonitrile as a constituent monomer. Herein, we use ‘polymer containing acrylonitrile monomer’ interchangeably with ‘polyacrylonitrile, or a copolymer of acrylonitrile and at least one other monomer, or a blend of either of the foregoing with one or more other polymers’.

It follows that the polymer containing acrylonitrile monomer may be a homopolymer-when it is polyacrylonitrile- or a copolymer. The polymer containing acrylonitrile monomer may be present as part of a blend of either polyacrylonitrile or a copolymer, together with one or more other polymers.

When the polymer containing acrylonitrile monomer is a copolymer, the copolymer may contain one or more than one kinds of monomer in addition to the acrylonitrile monomer. The copolymer may be any suitable kind of copolymer, such as a random copolymer, an alternating copolymer, or a block copolymer etc. The one or more kinds of monomer other than the acrylonitrile monomer may be of any suitable kind as long as they do not impair the effects of the invention. To achieve the effects of the invention, the inventors generally consider that a suitable copolymer comprises acrylonitrile monomers in an amount of at least 20 weight % (wt. %), such as at least 30 wt. %, 50 wt. % or at least 70 wt. % based on the weight of the copolymer.

When the polymer containing acrylonitrile monomer is part of a blend, any suitable other polymer(s) can be used to make up the blend so long as they do not impair the effects of the invention. To achieve the effects of the invention, the inventors generally consider that a suitable blend comprises at least 20 vol %, such as at least 30 vol %, 50 vol % or at least 70 vol % of the blend.

In general, it is preferred to use polyacrylonitrile, either alone or as part of a blend, in the invention.

In some embodiments, the polyacrylonitrile is not mixed as part of a blend with one or more other polymers i.e. it is used as the sole polymer component of the electrode precursor composition.

In some embodiments, the mixing step of the method of the invention comprises mixing polyacrylonitrile with the first organic solvent and the electrochemically active material, in the absence of the alkali metal salt, to form the electrode precursor composition.

The amount of polymer containing acrylonitrile monomer to be used in the electrode precursor composition can be any suitable amount. The lower limit is any which achieves the effects of the invention. The upper limit is determined by considering processability: too much polymer containing acrylonitrile monomer may have the disadvantage of being too soft.

In some embodiments, the volume ratio of the polyacrylonitrile, or a copolymer of acrylonitrile and at least one other monomer, or a blend of either of the foregoing with one or more other polymers, to the organic solvent is at least 1:1, for example at least 1:2, at least 1:3, at least 1:4, at least 1:5 or at least 1:6.

In some embodiments, the volume ratio of the polyacrylonitrile, or a copolymer of acrylonitrile and at least one other monomer, or a blend of either of the foregoing with one or more other polymers, to the organic solvent is up to 1:15, for example up to 1:13, up to 1:12, up to 1:11, up to 1:10, up to 1:9 or up to 1:8.

In some embodiments, the volume ratio of the polyacrylonitrile, or a copolymer of acrylonitrile and at least one other monomer, or a blend of either of the foregoing with one or more other polymers, to the organic solvent is between 1:1 and 1:15. Other combinations of the above values may be combined to form a suitable range, for example between 1:1 to 1:12, between 1:2 to 1:11, between 1:3 to 1:10 or between 1:4 to 1:8.

In some embodiments, the polyacrylonitrile, or a copolymer of acrylonitrile and at least one other monomer, or a blend of either of the foregoing with one or more other polymers makes up at least 0.5 vol % of the electrode precursor composition, for example at least 1 vol %, at least 2 vol % or at least 3 vol %.

In some embodiments, the polyacrylonitrile, or a copolymer of acrylonitrile and at least one other monomer, or a blend of either of the foregoing with one or more other polymers makes up up to 15 vol % of the electrode precursor composition, for example up to 12 vol %, up to 10 vol % or up to 8 vol %.

Accordingly, in some embodiments, the vol % amount of the polyacrylonitrile, or a copolymer of acrylonitrile and at least one other monomer, or a blend of either of the foregoing with one or more other polymers, to the organic solvent is between 0.5 and 15 vol %. Other combinations of the above values may be combined to form a suitable range, such as between 1 to 12 vol %, between 1 to 10 vol %, between 2 to 8 vol %, or between 3 to 8 vol %.

It is noted that the total vol % of all ingredients in the electrode precursor composition is 100 vol %.

In the method of the present invention, the polyacrylonitrile, or a copolymer of acrylonitrile and at least one other monomer, or a blend of either of the foregoing with one or more other polymers is mixed with an organic solvent and an electrochemically active material to form an electrode precursor composition. Any suitable mixing method can be employed. Typically, it is expected that the mixing step will result in a substantially homogeneous composition.

By way of example, a suitable method may comprise use of a twin screw extruder compound. In such method, the individual components are provided individually. They are subsequently mixed at a desired temperature to form the electrode precursor composition. Such method advantageously achieves mixing of all components in a single step.

The desired temperature referred to above is not particularly limited. Generally, and in the usual way, it is a temperature that is high enough to cause the mutual dissolution of the components to be dissolved while not so high as to cause degradation of the constituent components. Accordingly, the temperature chosen will depend on the nature of the components used in the electrode precursor composition.

The identity of the electrochemically active material used in the invention is not of particular importance. The benefits of the invention may be achieved for any active material which could be present in an electrode composition. The skilled person will be aware of a large number of possible electrochemically active materials, including cathode active materials (also called positive active materials) and anode active materials (also called negative active materials), which may be used in the present invention.

The electrochemically active material is typically a particulate material, i.e. a material made up of a plurality of discrete particles. The particles may comprise primary particles and/or secondary particles formed from the agglomeration of a plurality of primary particles.

In some embodiments, the electrochemically active material may be a positive active material. That is, the electrode functions as a cathode.

In some embodiments, the positive active material is a lithium transition metal oxide material. In some embodiments, the positive active material is a lithium transition metal oxide material comprising a mixed metal oxide of lithium and one or more transition metals, optionally further comprising one or more additional non-transition metals. In some embodiments, the positive active material is a lithium transition metal oxide material comprising lithium and one or more transition metals selected from nickel, cobalt and manganese. In some embodiments, the positive active material is selected from one or more of lithium cobalt oxide (LCO), lithium manganese oxide (LMO), lithium nickel cobalt oxide (NCO), aluminium-doped lithium nickel cobalt oxide (NCA), lithium nickel manganese cobalt oxide (NMC), lithium nickel oxide (LNO), lithium nickel manganese oxide (LNMO), lithium iron phosphate (LFP), lithium manganese iron phosphate (LFP) and lithium nickel vanadate (LNV). In some embodiments, the positive active material is lithium nickel manganese cobalt oxide (NMC), optionally doped with another metal such as aluminium.

Such electrochemically active materials are commercially available or may be manufactured by methods known to the skilled person, for example through the precipitation of mixed metal hydroxide intermediates from a reaction mixture containing different precursor metal salts, followed by calcination to form a mixed metal oxide and optionally lithiation to incorporate lithium into the oxide.

The electrochemically active materials may be undoped or uncoated or may contain one or more dopants and/or a coating. For example, the electrochemically active material may be doped with small amounts of one or more metal elements. The electrochemically active material may comprise a carbon coating on the surface of the particles of the material.

In some embodiments, the electrochemically active material makes up at least 55 vol % of the electrode precursor composition, for example at least 56 vol %, at least 57 vol %, at least 58 vol %, at least 59 vol %, at least 60 vol %, at least 61 vol %, or at least 62 vol %.

In some embodiments, the electrochemically active material makes up up to 75 vol % of the electrode precursor composition, for example up to 74 vol %, up to 73 vol %, up to 72 vol %, up to 71 vol %, up to 70 vol %, up to 69 vol % or up to 68 vol %.

In some embodiments the electrochemically active material makes up from 55 to 75 vol % of the electrode precursor composition. Other combinations of the above values may be combined to form a suitable range, for example from 55 to 70 vol %, from 55 to 69 vol %, from 55 to 68 vol %, from 58 to 68 vol %, or from 60 to 68 vol %.

In some embodiments the electrochemically active material makes up from 62 to 75 vol % of the electrode precursor composition, for example from 62 to 70 vol %, from 62 to 69 vol %, from 62 to 68 vol % or from 62 to 69 vol %.

The organic solvent used in the present invention is an organic solvent which is typically used in the manufacture of electrodes for alkali metal secondary cells. The organic solvent should suitably be capable of being blended with, e.g. to form a solution with the polymer containing acrylonitrile monomer and electrochemically active material.

In some embodiments, the organic solvent is non-aqueous. In some embodiments, the solvent comprises one or more cyclic or linear carbonate compounds. In some embodiments the solvent comprises one or more cyclic carbonate compounds. In some embodiments the solvent comprises one or more of ethylene carbonate, propylene carbonate, dimethyl carbonate, diethyl carbonate, ethyl-methyl carbonate, butylene carbonate, vinylene carbonate, fluoroethylene carbonate, fluoropropylene carbonate and γ-butyrolactone.

The relative amounts of solvent and polymer containing acrylonitrile monomer are discussed above.

In some embodiments, the organic solvent makes up at least 20 vol % of the electrode precursor composition, for example at least 21 vol %, at least 22 vol %, at least 23 vol %, at least 24 vol % or at least 25 vol %.

In some embodiments, the organic solvent makes up up to 40 vol % of the electrode precursor composition, for example up to 39 vol %, up to 38 vol %, up to 37 vol %, up to 36 vol % or up to 35 vol %.

In some embodiments the organic solvent makes up from 20 to 40 vol % of the electrode precursor composition. Other combinations of the above values may be combined to form a suitable range, for example between 22 and 38 vol %, between 22 and 37 vol %, between 23 and 36 vol % or between 25 and 35 vol %.

The present invention makes use of the sensitivity of the polymer containing acrylonitrile monomer to alkali metal salt. Therefore, the electrode precursor composition contains low amounts of, or no, added alkali metal salt. Accordingly, in some embodiments, the electrode precursor composition-either of the second aspect or as prepared in the mixing step of the method of the first aspect of the invention-contains a low amount of alkali metal salt, such as 1 wt. % or less, such as less than 0.5 wt. %, less than 0.2 wt. % or less than 0.1 wt. % or substantially 0 wt. %.

In some embodiments, the electrode precursor composition formed by the mixing step may comprise up to 25 wt. %, such as up to 15 wt. %, up to 10 wt. % or up to 5 wt. % of the total amount of alkali metal salt which is included in the electrode formed following the electrode formation step (the total amount being 100 wt. %).

In some embodiments, the electrode precursor composition formed by the mixing step may comprise up to 1 wt. % or 0 wt. % of the total amount of alkali metal salt which is included in the electrode formed following the electrode formation step.

Accordingly, in some embodiments, the electrode precursor composition comprises 0 wt. % to 25 wt. % of the total amount of alkali metal salt which is included in the electrode formed following the electrode formation step. Other combinations of the above values may be combined to form a suitable range, for example between 0 wt. % and 15 wt. %, between 0 wt. % and 10 wt. %, between 0 wt. % and 5 wt. % or between 0 wt. % and 1 wt. %.

The alkali metal of the alkali metal salt may be any suitable alkali metal (Group I of the periodic table). Typically, to the alkali metal may be lithium, sodium and potassium.

In some embodiments, the alkali metal of the alkali metal salt is lithium. In some embodiments, the alkali metal of the alkali metal salt which is both absent in the mixing step and added in the electrode formation step is lithium.

The anion of the alkali metal salt may be any suitable anion. Typical anions are known to the skilled person and may be chosen based on the kind of alkali metal. In some embodiments, when the alkali metal is lithium, the anion of the alkali metal salt comprises a halogen such as fluorine. Examples include BF₄⁻, PF₆⁻, TFSI⁻, FSI⁻ and TDI⁻.

In some embodiments, the alkali metal salt comprises one or more lithium salt(s). In some embodiments, the or each lithium salt is independently selected from: a lithium borate salt, a lithium imide salt, and a lithium imidazolide salt.

In some embodiments, the liquid electrolyte comprises one or more of lithium bis(oxalato) borate, lithium tetrafluoroborate, lithium difluoro (oxalate) borate (LiDFOB), lithium bis(trifluoromethanesulfonyl)imide (LiTFSI), lithium bis(fluorosulfonyl)imide (LiFSI) and lithium 2-trifluoromethyl-4,5-dicyanoimidaxolide (LiTDI). In some embodiments, the lithium salt is one or more of LiFSI, LiDFOB and LiTDI. Examples of the lithium salt will be known to the skilled person, but include for example one or more of LiBF₄, LiPF₆, LiTFSI, LIFSI and LiTDI.

One or more kinds of alkali metal salt may be used in accordance with the present invention. Typically, but not exclusively, when more than one kind of alkali metal salt is used, they share a common alkali metal.

In some embodiments, the electrode precursor composition further comprises an additive, for example a conductive additive. The conductive additive may be incorporated into the electrode precursor composition at any suitable time and using any suitable method. For example, the conductive additive may suitably be included together with the polyacrylonitrile, or a copolymer of acrylonitrile and at least one other monomer, or a blend of either of the foregoing with one or more other polymers, the first organic solvent and the electrochemically active material during the mixing step of the method of the invention. The conductive additive may be a particulate conductive additive.

In some embodiments, the conductive additive comprises or consists of one or more of carbon black, carbon nanotubes (including multi-wall and single-wall carbon nanotubes), carbon fibres, and graphite. In some embodiments, the conductive additive comprises or consists of carbon black. Examples of commercially available carbon black include Ketjen Black and Super C65.

In some embodiments, the conductive additive is present in an amount of from 0.5 vol % to 2.5 vol %, based on the total volume of electrode precursor composition, for example from 0.5 vol % to 2.5 vol %, from 0.5 vol % to 2.3 vol %, from 0.5 vol % to 2.1 vol %, from 0.7 vol % to 2.0 vol %, from 0.7 vol % to 1.8 vol % or from 0.7 vol % to 1.6 vol %.

In the method of the invention, the electrode precursor composition is formed into an electrode precursor.

In some embodiments, the electrode precursor formation step comprises thermal processing. That is, the electrode precursor formation step comprises a step of applying high temperature in a fluid state formation process.

In some embodiments the thermal processing comprises passing the electrode precursor composition through a roller assembly at a temperature of at least 50° C., for example at least 60° C., at least 70° C., at least 80° C., at least 90° C. or at least 100° C. In some embodiments the thermal processing comprises passing the electrode precursor composition through rollers at a temperature of up to 150° C., for example up to 140° C. or up to 130° C. In some embodiments the thermal processing comprises passing the electrode precursor composition through rollers at a temperature of from 50° C. to 150° C., for example from 60° C. to 150° C., from 70° C. to 150° C., from 80° C. to 150° C., from 80° C. to 140° C., from 90° C. to 140° C., from 100° C. to 140° C. or from 110° C. to 130° C.

The roller assembly may comprise two rollers separated by a small distance such that the electrode precursor composition is pressed into a thin film when passed through the rollers.

In some embodiments the thermal processing comprises extruding the electrode. In some embodiments the thermal processing comprises extruding the electrode using an extrusion apparatus comprising one or more screw feeding sections and an extrusion die. In some embodiments, the temperature of the die is at least 50° C., for example at least 60° C., at least 70° C., at least 80° C., at least 90° C. or at least 100° C. In some embodiments the temperature of the die is up to 150° C., for example up to 140° C. or up to 130° C. In some embodiments the temperature of the die is from 50° C. to 150° C., for example from 60° C. to 150° C., from 70° C. to 150° C., from 80° C. to 150° C., from 80° C. to 140° C., from 90° C. to 140° C., from 100° C. to 140° C. or from 110° C. to 130° C.

In some embodiments the electrode precursor has a thickness of less than 150 μm, for example less than 100 μm, less than 90 μm, less than 80 μm or less than 70 μm. In some embodiments the electrode precursor has a thickness of from 40 to 150 μm, for example from 40 to 100 μm, from 40 to 90 μm, from 40 to 80 μm, from 40 to 70 μm or from 50 to 70 μm.

In some embodiments the electrode precursor has a thickness of from 40 to 150 μm, for example from 40 to 100 μm, from 40 to 90 μm, from 40 to 80 μm, from 40 to 70 μm or from 50 to 70 μm, and comprises the electrochemically active material in an amount of from 60 to 75 vol % of the electrode precursor composition, for example from 60 to 70 vol %, from 60 to 69 vol %, from 60 to 68 vol % or from 62 to 69 vol %.

In some cases, the extruded electrode may for part of an extruded monolith which includes one or more further layers which are present in an electrochemical battery. For instance, the monolith may include a separator layer, and/or may include the other electrode (i.e. the extruded monolith may include both a cathode and anode). The different layers may be coextruded and have different compositions from one another.

In some embodiments, in the electrode formation step, exposing the electrode precursor to an alkali metal salt comprises exposing the electrode precursor to a solution or gel comprising an alkali metal salt.

In some embodiments, in the electrode formation step, exposing the electrode precursor to an alkali metal salt comprises exposing the electrode precursor to a lithium salt. In some embodiments, in the electrode formation step, exposing the electrode precursor to a solution or gel comprising an alkali metal salt comprises exposing the electrode precursor to a solution or gel comprising a lithium salt.

In some embodiments, the solution comprising the alkali metal salt comprises a second organic solvent, preferably wherein the second organic solvent is the same as the first organic solvent. Accordingly, all the above-mentioned discussion of the organic solvent applies both to the electrode precursor composition and to the electrode formation step in the method of the invention.

A particularly useful embodiment of the method of the invention comprises exposing the electrode precursor to the alkali metal salt in situ, for example in an alkali metal secondary cell. For example, the alkali metal salt can be (comprised in) a liquid electrolyte.

In this way, the hardening of the electrode can be caused at a desired time, rather than requiring handling of an already-hardened electrode.

In some embodiments, the electrode film has a thickness of from 500 to 700 μm.

In some embodiments, the method of the invention further comprises shaping and/or cutting the electrode precursor and/or electrode to form an electrode precursor or electrode of predetermined dimensions.

In some embodiments, the method of the invention further comprises performing a second thermal processing step on a cut film to reduce the thickness of the film to within a range of 50 to 70 μm.

In some embodiments, the temperature during that thermal processing step is from 100 to 140° C.

Also provided herein as an aspect of the invention is an electrode prepared by a method of the invention or from an electrode precursor composition of the invention. Also provided as an aspect of the invention is an electrochemical secondary cell comprising such electrode. The cell may be an alkali metal ion secondary cell, for example a sodium-ion secondary cell or a lithium-ion secondary cell. Preferably the cell is a lithium-ion secondary cell. In some embodiments the electrochemical secondary cell comprises a first electrode according to the invention, wherein the first electrode is a cathode, and a second electrode according to the invention, wherein the second electrode is an anode, and an electrolyte between the cathode and the anode. In some embodiments, the electrolyte is a liquid electrolyte. In some embodiments, the liquid electrolyte comprises or is a solution comprising an alkali metal salt as described herein.

In some embodiments the electrochemical secondary cell comprises an electrode according to the invention laminated with a current collector, for example a metallic foil.

Also provided herein as an aspect of the invention is an electrochemical energy storage device comprising an electrochemical secondary cell of the invention. In some embodiments, the electrochemical energy storage device is a battery. In some embodiments, the electrochemical energy storage device is a lithium-ion battery.

### EXAMPLES

The following is an exemplary electrode precursor composition according to the present invention:

| Ingredient | Vol % of Composition |
|---|---|
| Cathode active (for example NMC) | 64 |
| PAN polymer | 5 |
| Propylene carbonate | 30 |
| Conductive carbon | 1 |

1. A method of preparing an electrode for an alkali metal ion secondary cell, the method comprising:
mixing polyacrylonitrile, or a copolymer of acrylonitrile and at least one other monomer, or a blend of either of the foregoing with one or more other polymers, with a first organic solvent and an electrochemically active material, to form an electrode precursor composition;
forming the electrode precursor composition into an electrode precursor; and
exposing the electrode precursor to an alkali metal salt to form the electrode.

2. The method according to claim 1, wherein the mixing is carried out in the presence of between 0 and 1 wt. % of an alkali metal salt.

3. The method according to claim 1, wherein the exposing comprises exposing the electrode precursor to a solution or gel comprising the alkali metal salt.

4. The method according to claim 3, wherein the solution comprising the alkali metal salt comprises a second organic solvent.

5. The method according to claim 1, wherein the mixing step comprises mixing polyacrylonitrile with the first organic solvent and the electrochemically active material, to form the electrode precursor composition.

6. The method according to claim 1, wherein the electrode precursor formation step forming comprises thermal processing.

7. The method according to claim 1, wherein in the mixing, the volume ratio of the polyacrylonitrile, or a copolymer of acrylonitrile and at least one other monomer, or a blend of either of the foregoing with one or more other polymers, to the organic solvent is between 1:1 and 1:15.

8. The method according to claim 1 wherein the mixing is carried out in the absence of a lithium salt, and/or in the exposing, the alkali metal salt comprises a lithium salt.

9. The method according to claim 1, wherein the exposing is carried out in an alkali metal ion secondary cell.

10. The method according to claim 1, wherein the organic solvent comprises a carbonate.

11. An electrode precursor composition suitable for preparing a gel electrode, the composition comprising polyacrylonitrile, or a copolymer of acrylonitrile and at least one other monomer, or a blend of either of the foregoing with one or more other polymers, an organic solvent, and electrochemically active material, which composition is free or substantially free of alkali metal salt.

12. The electrode precursor composition according to claim 11, wherein a volume ratio of the polyacrylonitrile, or the copolymer of acrylonitrile and at least one other monomer, or the blend of either of the foregoing with one or more other polymers, to the organic solvent is between 1:1 and 1:15.

13. The electrode precursor composition according to claim 11, wherein the composition is free or substantially free of lithium salt.

14. The electrode precursor composition according to claim 11, wherein the organic solvent comprises a carbonate.

15. The electrode precursor composition according to claim 11, wherein the polyacrylonitrile, or a copolymer of acrylonitrile and at least one other monomer, or a blend of either of the foregoing with one or more other polymers, is present in an amount of between 1-10 vol. %, based on the total volume of electrode precursor composition.

16. The electrode precursor composition according to claim 11, wherein the organic solvent is present in an amount of at least 20 vol. %, based on the total volume of electrode precursor composition.

17. The electrode precursor composition according to claim 11, wherein the electrochemically active material is present in an amount of at least 60 vol. %, based on the total volume of electrode precursor composition.

18. The electrode precursor composition according to claim 11, further comprising a conductive additive.

19. The electrode precursor composition according to claim 18, wherein the conductive additive is present in an amount of from 0.1 wt. % to 3 wt. %, based on the total weight of electrode precursor composition.

20. An electrode precursor composition according to claim 11, wherein the composition comprises polyacrylonitrile.

21. (canceled)

22. (canceled)

23. (canceled)

24. (canceled)

25. (canceled)

26. (canceled)

27. (canceled)
